(19) United States
(12) Patent Application Publication
(10) Pub. No.: US 2022/0097178 A1
(43) Pub. Date: Mar. 31, 2022

(54) REPAIR WELDING CONTROL DEVICE AND REPAIR WELDING CONTROL METHOD

(71) Applicant: Panasonic Intellectual Property Management Co., Ltd., Osaka (JP)

(72) Inventors: Toshinari MOHRI, Osaka (JP); Takamichi KOMATSU, Osaka (JP); Katsuaki OKUMA, Osaka (JP)

(21) Appl. No.: 17/548,916

(22) Filed: Dec. 13, 2021

Related U.S. Application Data
(63) Continuation of application No. PCT/JP2020/023287, filed on Jun. 12, 2020.

(30) Foreign Application Priority Data
Jun. 14, 2019 (JP) 2019-111619
Dec. 6, 2019 (JP) 2019-221254

(51) Int. Cl. B23K 31/12; B23K 9/095

(52) U.S. Cl. CPC B23K 31/125; B23K 9/095

(57) ABSTRACT

A repair welding control device includes a memory that stores instructions and a processor that executes the instructions. The instructions cause the processor to perform acquiring information indicating a range of a defective portion in main welding of a workpiece, and determining a repair welding start point indicating a start point of repair welding and a repair welding end point indicating an end point of the repair welding such that a repair welding range includes all the range of the defective portion and a range wider than the range of the defective portion.

### CROSS-REFERENCE TO RELATED APPLICATIONS

This is a continuation of International Application No. PCT/JP2020/023287 filed on Jun. 12, 2020, and claims priority from Japanese Patent Application No. 2019-111619 filed on Jun. 14, 2019 and Japanese Patent Application No. 2019-221254 filed on Dec. 6, 2019, the entire contents of which are incorporated herein by reference.

### TECHNICAL FIELD

The present disclosure relates to a repair welding control device and a repair welding control method.

### BACKGROUND ART

JP-A-2012-037487 discloses a shape inspection device for inspecting a shape of an inspection object using an imaging optical system, the shape inspection device includes: a projection unit configured to project slit light onto the inspection object; an imaging unit configured to image shape lines sequentially formed on the inspection object by scanning of the slit light; a point group data acquisition unit configured to acquire a three-dimensional shape of the inspection object as point group data based on imaging data of each of the sequentially formed shape lines; a cutting line setting unit configured to set a cutting line according to input to the inspection object displayed based on the point group data; and a cross-sectional shape calculation unit configured to calculate a cross-sectional shape of the inspection object at the cutting line based on the point group data corresponding to the cutting line.

### SUMMARY OF INVENTION

The present disclosure provides a repair welding control device and a repair welding control method capable of determining a more appropriate repair line.

The present disclosure provides a repair welding control device including a memory that stores instructions; and a processor that executes the instructions, in which the instructions cause the processor to perform: acquiring information indicating a range of a defective portion in main welding of a workpiece, and determining a repair welding start point indicating a start point of repair welding and a repair welding end point indicating an end point of the repair welding such that a repair welding range includes all the range of the defective portion and a range wider than the range of the defective portion.

Further, the present disclosure also provides a repair welding control method using an device including a processor, and the processor is configured to acquire information indicating a range of a defective portion in main welding of a workpiece, and determine a repair welding start point indicating a start point of repair welding and a repair welding end point indicating an end point of the repair welding such that a repair welding range includes all the range of the defective portion and a range wider than the range of the defective portion.

According to the present disclosure, a more appropriate repair line can be determined.

### BRIEF DESCRIPTION OF DRAWINGS

FIG. 1 is a schematic diagram showing an example of a use case of a repair welding system 1000 according to the present disclosure.

FIG. 2 is a diagram showing an internal configuration example of a repair welding system 1000a related to control of a robot MC according to a first embodiment.

FIG. 3 is a flowchart showing an operation procedure example of repair line determination by the repair welding system 1000a according to the first embodiment.

FIG. 4 is a conceptual diagram showing repair line determination processing shown in FIG. 3.

FIG. 5 is a conceptual diagram showing the repair line determination processing shown in FIG. 3.

FIG. 6 is a conceptual diagram showing a pattern of a plurality of welding lines.

FIG. 7A is a conceptual diagram showing a first determination mode.

FIG. 7B is a conceptual diagram showing a use case of the first determination mode.

FIG. 8A is a conceptual diagram showing a second determination mode.

FIG. 8B is a conceptual diagram showing a use case of the second determination mode.

FIG. 9A is a conceptual diagram showing a third determination mode.

FIG. 9B is a conceptual diagram showing a use case of the third determination mode.

### DESCRIPTION OF EMBODIMENTS

### Background of Present Disclosure

In the technique of JP-A-2012-037487, an appearance inspection device can determine whether a shape of a welded portion is good or bad after main welding is performed. However, in a case where the shape is not good, it is currently determined whether rewelding (repair welding) can be performed to determine whether repair can be performed, and rewelding (repair welding) for repair is performed by a welding operator who is a human.

Further, regarding the repair welding in the case where the defective portion of the welding can be determined, the welding operator who is a human also determines a portion on the workpiece where the repair welding is appropriate. Therefore, there is a potential problem that the quality is not stable due to a skill level difference or an erroneous determination of an operator.

Therefore, in the present disclosure, the device automatically determines an appropriate start position and an appropriate end position of the repair welding for the defective shape portion of the workpiece subjected to the main welding, and performs the repair welding. Accordingly, the repair welding for improving and stabilizing the welding quality can be performed.

Hereinafter, embodiments specifically disclosing configurations and operations of a repair welding system and a repair welding method according to the present disclosure will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy of the following description and to facilitate understanding of a person skilled in the art. The attached diagrams and the following description are provided in order for a person skilled in the art to sufficiently understand the present disclosure, and are not intended to limit the matters described in the scope of the claims.

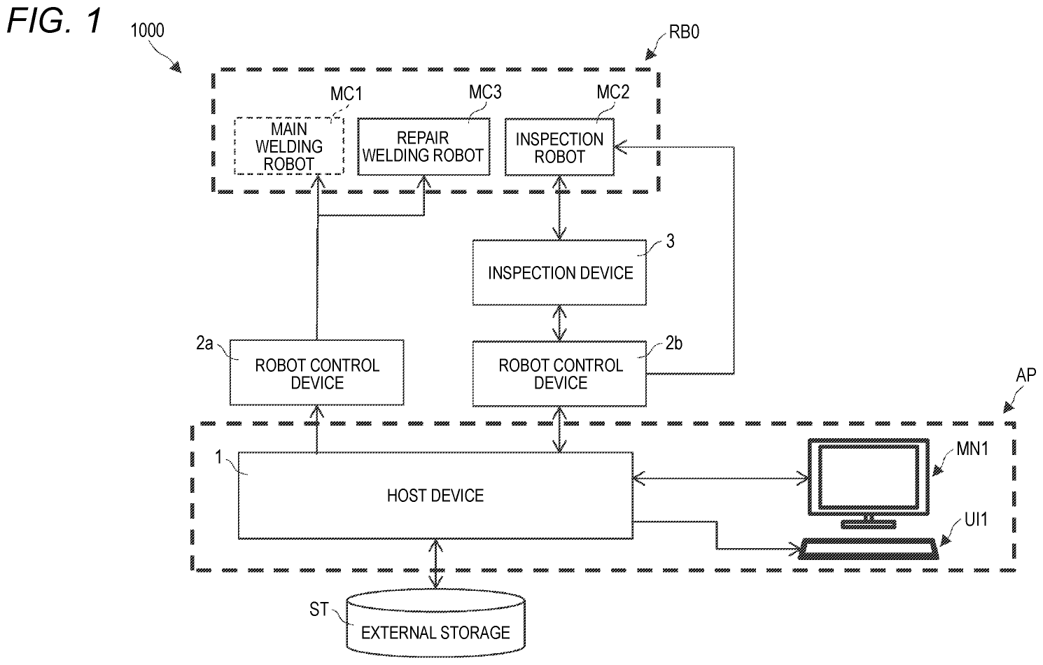

FIG. 1 is a schematic diagram showing an example of a use case of a repair welding system 1000 according to the present disclosure. The repair welding system 1000 according to the present disclosure is a system that automatically performs, based on information input by a user or information related to welding set in advance, inspection of a welded portion actually main-welded to a workpiece Wk and repair welding (repair welding) of a defective portion determined to be defective among the welded portions. The system may perform the main welding in addition to the above-described inspection and repair welding. Further, the repair welding system 1000 can further perform repair welding on a defective portion of the workpiece Wk on which repair welding has already been performed. Therefore, the “main welding” in the present application may include repair welding performed before the next repair welding is performed.

The repair welding system 1000 may roughly include three devices of a robot (RBO) used for welding or inspection of a welding result, a controller that controls the robot or an inspection function of the robot, and a host device for the controller.

More specifically, the repair welding system 1000 may include a main welding robot MC1 that performs the main welding, an inspection robot MC2 that performs appearance inspection of a welded portion after the main welding, and a repair welding robot MC3 that performs repair welding when a defective portion is included in the welded portion after the main welding. Further, the welding system may include a robot control device 2a, an inspection device 3, and a robot control device 2b as controllers for controlling the above-described various robots and inspection functions of the robots. Further, the repair welding system 1000 may include a host device 1 for the above-described controller. The host device 1 may be connected to a monitor MN1, an interface UI1, and an external storage ST.

Although not shown, the host device 1 or various control devices included in the controller may include a communication interface (wired or wireless) that performs communication with an external network. When these devices are connected to the external network, these devices can communicate with other devices (typically, a server, a PC, various sensor devices, and the like) existing on the external network.

In FIG. 1, the main welding robot MC1 is shown as a robot different from the repair welding robot MC3. However, the main welding robot MC1 may be omitted in a case where the repair welding system 1000 executes the inspection and the repair welding after the main welding is performed using another system or the main welding is performed manually.

Further, the main welding robot MC1 may be integrated with each of the repair welding robot MC3 and the inspection robot MC2. For example, the repair welding robot MC3 may execute, by the same robot, the main welding for welding the workpiece Wk and the repair welding for repairing the defective portion among the welded portions welded by the main welding. Further, for example, the inspection robot MC2 may execute, by the same robot, the main welding for welding the workpiece Wk and the inspection for inspecting whether there is a defective portion among the welded portions welded by the main welding.

The inspection robot MC2 and the repair welding robot MC3 may be integrated into one robot, and the main welding robot MC1, the inspection robot MC2, and the repair welding robot MC3 may be integrated into one robot.

In the repair welding system 1000 shown in FIG. 1, the number of each of the main welding robots MC1, the inspection robots MC2, and the repair welding robots MC3 is not limited to the number shown in FIG. 1. For example, the number of each of the main welding robots MC1, the inspection robots MC2, and the repair welding robots MC3 may be plural or may not be the same. For example, the repair welding system 1000 may include one main welding robot MC1, three inspection robots MC2, and two repair welding robots MC3. Accordingly, the repair welding system 1000 can be adaptively configured according to a processing range, a processing speed, and the like of each robot as necessary.

The host device 1 is communicably connected to the monitor MN1, the interface UI1, the external storage ST, the robot control device 2a, and the robot controller 2b. Further, although the host device 1 shown in FIG. 1 is connected to the inspection device 3 via the robot control device 2b, the host device 1 may be directly communicably connected to the inspection device 3 without using the robot control device 2b.

The host device 1 may be a terminal device AP integrally configured to include the monitor MN1 and the interface UI1, or may be integrally configured to further include the external storage ST. In this case, the terminal device AP is, for example, a personal computer (PC) used by a user (operator) in executing welding. The terminal device AP is not limited to the PC described above, and may be a computer having a communication function, such as a smartphone, a tablet terminal, and a personal digital assistant (PDA).

The host device 1 generates each of control signals for executing the main welding, the inspection of the welded portion, and the repair welding of the defective portion on the workpiece Wk based on an input operation by a user (operator) or information set in advance by the user (operator). The host device 1 transmits, to the robot control device 2a, a control signal for executing the main welding on the generated workpiece Wk and a control signal for executing the repair welding on the defective portion. Further, the host device 1 transmits, to the robot control device 2b, a control signal for executing the inspection of the welded portion welded by the main welding.

The host device 1 may collect an inspection result of the welded portion received from the inspection device 3 via the robot control device 2b. The host device 1 transmits the received inspection result to the external storage ST and the monitor MN1. Although the inspection device 3 shown in FIG. 1 is connected to the host device 1 via the robot control device 2b, the inspection device 3 may be directly communicably connected to the host device 1.

The monitor MN1 may be configured using, for example, a display such as a liquid crystal display (LCD) or an organic electroluminescence (EL). The monitor MN1 displays the inspection result and an alert of the welded portion received from the inspection device 3. The monitor MN1 may be configured using, for example, a speaker (not shown), and may notify an alert by voice when the alert is received. That is, a form for performing the notification is not limited to the notification by visual information.

The interface UI1 is a user interface (UI) that detects an input operation of a user (operator), and is configured using a mouse, a keyboard, a touch panel, and the like. The interface UI1 transmits an input operation based on the input operation of the user to the host device 1. The interface UI1 receives, for example, input of a welding line, a setting of an inspection criteria according to the welding line, an operation of starting or ending an operation of the repair welding system 1000, and the like.

The external storage ST is configured using, for example, a hard disk drive (HDD) or a solid state drive (SSD). The external storage ST may store the inspection result of the welded portion received from the host device 1.

The robot control device 2a is communicably connected to the host device 1, the main welding robot MC1, and the repair welding robot MC3. The robot control device 2a receives the control information related to the main welding received from the host device 1, controls the main welding robot MC1 based on the received control information, and causes the main welding robot MC1 to execute the main welding on the workpiece Wk.

The robot control device 2a receives control information related to the repair welding received from the host device 1. The robot control device 2a controls the repair welding robot MC3 based on the received control information, and causes the repair welding robot MC3 to execute the repair welding on the defective portion determined to be defective by the inspection device 3 among the welded portions.

The robot control device 2a shown in FIG. 1 controls each of the main welding robot MC1 and the repair welding robot MC3. However, in the repair welding system 1000 according to a first embodiment, for example, each of the main welding robot MC1 and the repair welding robot MC3 may be controlled using different control devices. Furthermore, in the repair welding system 1000 according to the first embodiment, the main welding robot MC1, the inspection robot MC2, and the repair welding robot MC3 may be controlled by a single control device.

The robot control device 2b is communicably connected to the host device 1, the inspection device 3, and the inspection robot MC2. The robot control device 2b receives information (for example, position information of a welded portion) related to the welded portion received from the host device 1. The welded portion includes a welded portion on the workpiece Wk (that is, a portion welded by the main welding) and a welded portion repaired and welded by the repair welding. The robot control device 2b controls the inspection robot MC2 based on the received information related to the welded portion, and causes the inspection robot MC2 to detect a shape of a welding bead in the welded portion. Further, the robot control device 2b transmits the received information related to the welded portion to the inspection device 3 that inspects a shape of the welded portion. The robot control device 2b transmits the inspection result received from the inspection device 3 to the host device 1.

The inspection device 3 is communicably connected to the robot control device 2b and the inspection robot MC2. The inspection device 3 inspects (determines) the presence or absence of a welding defect in the welded portion based on the information related to the welded portion received from the robot control device 2b and shape data of the welding bead of the welded portion generated by a shape detection unit 500. The inspection device 3 transmits, to the robot control device 2b as an inspection result, information (for example, a range of a defective portion, position information of the defective portion, a defect factor, and the like may be included) related to a defective portion determined to be defective among the welded portions acquired by the inspection (determination). Further, when it is determined that the defective portion can be repair-welded, the inspection device 3 may also transmit information such as a type of repair, a parameter for performing repair welding, and the like to the robot control device 2b as the inspection result. The inspection device 3 may be directly communicably connected to the host device 1. In this case, the inspection device 3 may be able to transmit the above-described information to the host device 1 without using the robot control device 2b.

In FIG. 1, the robot control device 2b and the inspection device 3 are described as separate bodies, but the robot control device 2b and the inspection device 3 may be integrated into a single device.

The main welding robot MC1 is a robot that is communicably connected to the robot control device 2a and executes welding (main welding) on a workpiece that has not been subjected to welding processing. The main welding robot MC1 executes the main welding on the workpiece Wk based on the control signal received from the robot control device 2a.

The inspection robot MC2 is communicably connected to the robot control device 2b and the inspection device 3. The inspection robot MC2 acquires the shape data of the welding bead of the welded portion based on the control signal received from the robot control device 2b.

The repair welding robot MC3 is communicably connected to the robot control device 2a. The repair welding robot MC3 executes the repair welding on the defective portion based on the inspection result of the welded portion (that is, information related to the defective portion) received from the robot control device 2a.

### First Embodiment

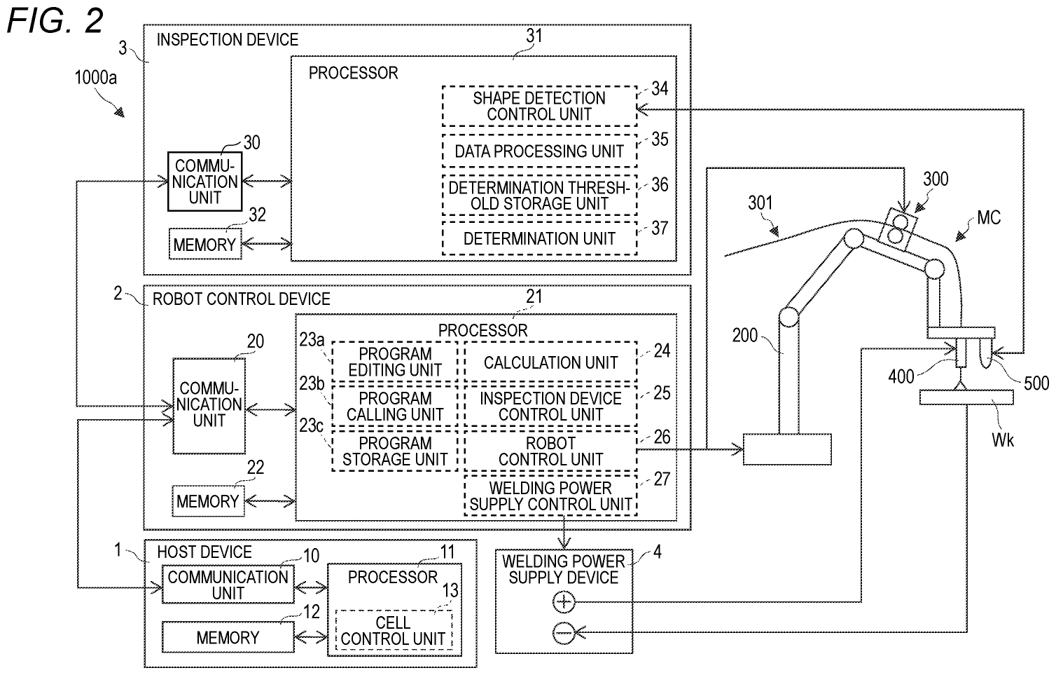

FIG. 2 is a diagram showing an internal configuration example of a repair welding system 1000a related to control of a robot MC according to a first embodiment. The robot MC shown in FIG. 2 is a robot in which the main welding robot MC1, the inspection robot MC2, and the repair welding robot MC3 shown in FIG. 1 are integrated. Further, in order to make the description easy to understand, configurations related to the monitor MN1, the interface UI1, and the external storage ST are omitted.

### Configuration Example of Robot MC

The robot MC performs main welding on the workpiece Wk based on a control signal received from a robot control device 2. The robot MC executes inspection of a welded portion in the workpiece Wk after the main welding is performed. Further, the robot MC performs repair welding on a welding defective portion in the welded portion of the workpiece Wk based on the control signal received from the robot control device 2.

In this example, the robot MC is a robot that performs arc welding. However, the robot MC may be, for example, a robot that performs laser welding and the like other than the arc welding. In this case, although not shown, instead of a welding torch 400, a laser head may be connected to a laser oscillator via an optical fiber.

In the present embodiment, the robot MC that performs the arc welding includes a manipulator 200, a wire feeding device 300, a welding wire 301, the welding torch 400, and the shape detection unit 500.

The manipulator 200 includes an articulated arm, and the arm moves based on a control signal received from a robot control unit 26 of the robot control device 2. As a result, positions of the welding torch 400 and the shape detection unit 500 can be controlled. An angle of the welding torch 400 with respect to the workpiece Wk can also be changed by the movement of the arm.

The wire feeding device 300 controls a feeding speed of the welding wire 301 based on the control signal received from the robot control device 2. The wire feeding device 300 may include a sensor capable of detecting a remaining amount of the welding wire 301.

The welding wire 301 is held by the welding torch 400, and when electric power is supplied to the welding torch 400 from a welding power supply device 4, an arc is generated between a tip end of the welding wire 301 and the workpiece Wk to perform the arc welding. The illustration and description of the configuration and the like for supplying shielding gas to the welding torch 400 are omitted for convenience of description.

The shape detection unit 500 included in the robot MC detects a shape of a welding bead in the welded portion based on the control signal received from the robot control device 2, and acquires shape data for each welding bead based on a detection result. The robot MC transmits the acquired shape data for each welding bead to the inspection device 3.

The shape detection unit 500 is, for example, a three-dimensional shape measurement sensor. The shape detection unit 500 includes a laser light source (not shown) configured to be able to scan the welded portion on the workpiece Wk based on position information of the welded portion received from the robot control device 2, and a camera (not shown) disposed to be able to image an imaging region including the periphery of the welded portion and configured to image a reflection trajectory (that is, a shape line of the welded portion) of the reflected laser light among the laser light emitted to the welded portion. The shape detection unit 500 transmits, to the inspection device 3, the shape data (image data) of the welded portion based on the laser light imaged by the camera.

The above-described camera (not shown) includes at least a lens (not shown) and an image sensor (not shown). The image sensor is, for example, a solid-state imaging device such as a charge-coupled device (CCD) or a complementary metal oxide semiconductor (CMOS), and converts an optical image formed on an imaging surface into an electric signal.

### Host Device

Next, the host device 1 will be described. The host device 1 generates a control signal for executing repair welding based on an input operation by a user (operator) or information set in advance by the user (operator), and transmits the generated control signal to the robot control device 2. The host device 1 includes a communication unit 10, a processor 11, and a memory 12.

The communication unit 10 is communicably connected to the robot control device 2. The communication unit 10 transmits the control signal for executing the repair welding to the robot control device 2. The control signal for executing the repair welding referred to here may include a control signal for controlling each of the manipulator 200, the wire feeding device 300, and the welding power supply device 4.

The processor 11 is configured using, for example, a central processing unit (CPU) or a field programmable gate array (FPGA), and performs various processing and control in cooperation with the memory 12. Specifically, the processor 11 implements a function of a cell control unit 13 by referring to a program and data stored in the memory 12 and executing the program.

The cell control unit 13 generates a control signal for executing the repair welding based on an input operation by a user (operator) using the interface UI1 and information set in advance by the user (operator) and stored in the external storage ST. The control signal generated by the cell control unit 13 is transmitted to the robot control device 2 via the communication unit 10.

The memory 12 includes, for example, a random access memory (RAM) as a work memory used when each processing of the processor 11 is executed, and a read only memory (ROM) that stores a program and data defining an operation of the processor 11. Data or information generated or acquired by the processor 11 is temporarily stored in the RAM. A program that defines the operation of the processor 11 is written in the ROM.

Further, the memory 12 stores an information type related to the workpiece Wk, a workpiece serial number (S/N) given in advance for each workpiece Wk, a welding line ID given for each welded portion (welding line) set by the user, and the like.

### Robot Control Device 2

Next, the robot control device 2 will be described. The robot control device 2 controls each of the manipulator 200, the wire feeding device 300, and the welding power supply device 4 based on the control signal received from the host device 1. The robot control device 2 includes a communication unit 20, a processor 21, and a memory 22. The processor 21 includes a program editing unit 23a, a program calling unit 23b, a program storage unit 23c, a calculation unit 24, an inspection device control unit 25, a robot control unit 26, and a welding power supply control unit 27.

The communication unit 20 is communicably connected to the host device 1. The communication unit 20 receives, from the host device 1, a control signal for executing main welding, repair welding, and appearance inspection by the inspection device 3.

The processor 21 is configured using, for example, a CPU or an FPGA, and performs various processing and control in cooperation with the memory 22. Specifically, the processor 21 refers to a program and data stored in the memory 22, and executes the program to implement the functions of the respective units. The respective units are the program editing unit 23a, the program calling unit 23b, the program storage unit 23c, the calculation unit 24, the inspection device control unit 25, the robot control unit 26, and the welding power supply control unit 27. The functions of the respective units are, for example, a function of editing and calling a repair welding program for executing repair welding stored in advance, a function of generating a control signal for controlling each of the manipulator 200, the wire feeding device 300, and the welding power supply device 4 based on the called repair welding program, and the like.

The memory 22 includes, for example, a RAM as a work memory used when each processing of the processor 21 is executed, and a ROM that stores programs and data defining the operation of the processor 21. Data or information generated or acquired by the processor 21 is temporarily stored in the RAM. A program that defines the operation of the processor 21 is written in the ROM.

The program editing unit 23a edits a program (control signal) for executing repair welding based on information (for example, a determination result by the inspection device 3) related to a defective portion received from the inspection device 3 via the communication unit 20. The program editing unit 23a refers to a repair welding basic program for executing repair welding stored in advance in the program storage unit 23c, and edits the repair welding program according to the received position and defect factor of the defective portion, parameters (repair parameters) for the repair welding, and the like. The edited repair welding program may be stored in the program storage unit 23c, or may be stored in the RAM and the like in the memory 22.

The repair welding program referred to here may include parameters such as a current, a voltage, an offset amount, a speed, a posture, and a method for controlling the welding power supply device 4, the manipulator 200, the wire feeding device 300, the welding torch 400, the shape detection unit 500, and the like when executing the repair welding.

The program calling unit 23b calls various programs stored in the ROM included in the memory 22, the program storage unit 23c, and the like. The program calling unit 23b may call a program on the robot MC side. Further, the program calling unit 23b can select and call an appropriate program from a plurality of programs according to the inspection result (determination result) by the inspection device 3. That is, the program calling unit 23b can change the program according to the inspection result (determination result) by the inspection device 3.

The program storage unit 23c stores various programs used by the robot control device 2. For example, the above-described repair welding basic program, the repair welding program edited by the program editing unit 23a, and the like may be stored in the program storage unit 23c.

The calculation unit 24 is a functional block that performs various calculations. For example, based on the repair welding program, calculations and the like for controlling the manipulator 200 and the wire feeding device 300 controlled by the robot control unit 26 are performed. Further, the calculation unit 24 may calculate an offset amount necessary for the repair welding for the defective portion based on the position of the defective portion.

The inspection device control unit 25 generates a control signal for controlling the inspection device 3. The control signal is transmitted to the inspection device 3 via the communication unit 20. On the contrary, the inspection device control unit 25 receives various information from the inspection device 3 via the communication unit 20, and performs various processing such as editing the repair welding program based on the information (program editing unit 23a) and transmitting a notification to the host device 1.

The robot control unit 26 drives each of the manipulator 200 and the wire feeding device 300 based on the repair welding program called by the program calling unit 23b or stored in the program storage unit 23c or a calculation result from the calculation unit 24. The welding power supply control unit 27 drives the welding power supply device 4 based on the repair welding program called by the program calling unit 23b or stored in the program storage unit 23c or the calculation result from the calculation unit 24.

In a case of a configuration in which the inspection robot MC2 and the repair welding robot MC3 are separated from each other, the information related to the defective portion may be transmitted from the inspection device 3 connected to the inspection robot MC2 to the robot control device 2 connected to the repair welding robot MC3 via the host device 1. The program editing unit 23a of the robot control device 2 connected to the repair welding robot MC3 may edit a program (control signal) for executing the repair welding based on information (for example, a determination result by the inspection device 3 to be described later) related to the defective portion received from the host device 1 via the communication unit 20.

Further, in the above configuration example, a form in which the program editing unit 23a and the program calling unit 23b are provided on the robot control device 2 side has been described. However, the program editing unit and the program calling unit may be provided on the inspection device 3 side. In this case, the inspection device 3 may call the above-described program or edit the repair welding program. A calling source of the program is not limited to the inside of the inspection device 3, and a program may be called from the robot control device 2, the robot MC connected to the robot control device 2, and the like. The called program is edited by the program editing unit. The edited program is transmitted from the inspection device 3 to the robot control device 2 as a repair welding program, and the robot control device 2 can perform repair welding using the repair welding program.

### Inspection Device 3

Next, the inspection device 3 will be described. The inspection device 3 inspects (determines) the welded portion of the workpiece Wk based on the shape data of the welding bead for each welded portion acquired by the shape detection unit 500.

The inspection device 3 includes a communication unit 30, a processor 31, a memory 32, a shape detection control unit 34, a data processing unit 35, a determination threshold storage unit 36, and a determination unit 37.

The communication unit 30 is communicably connected to the robot control device 2. The communication unit 30 may be directly communicably connected to the host device 1. The communication unit 30 receives information related to the welded portion from the host device 1 or the robot control device 2. The information related to the welded portion may include, for example, a workpiece type, the workpiece S/N, the welding line ID, and the like.

The inspection device 3 transmits the inspection result of the welded portion to the host device 1 or the robot control device 2 via the communication unit 30.

The processor 31 is configured using, for example, a CPU or an FPGA, and performs various processing and control in cooperation with the memory 32. Specifically, the processor 31 refers to a program and data stored in the memory 32, and executes the program to implement the functions of the respective units. Each unit includes the shape detection control unit 34, the data processing unit 35, the determination threshold storage unit 36, and the determination unit 37. The function of each unit is, for example, a function of controlling the shape detection unit 500 based on a control signal related to inspection corresponding to the welded portion received from the robot control device 2, a function of generating image data based on the shape data of the welding bead received from the shape detection unit 500, a function of executing the inspection on the welded portion based on the generated image data, and the like.

In a case of performing machine learning to be described later, the processor 31 may include, for example, a plurality of GPUs for calculation. In this case, the processor 31 may use a GPU in combination with the above-described CPU and the like.

The memory 32 includes, for example, a RAM as a work memory used when each processing of the processor 31 is executed, and a ROM that stores programs and data defining the operation of the processor 31. Data or information generated or acquired by the processor 31 is temporarily stored in the RAM. A program that defines the operation of the processor 31 is written in the ROM. Further, the memory 32 may include, for example, a hard disk drive (HDD) or a solid state drive (SSD).

The shape detection control unit 34 controls the shape detection unit 500 based on the shape data of the welding bead in the welded portion received from the shape detection unit 500 and the control signal related to the inspection corresponding to the welded portion received from the robot control device 2. When the shape detection unit 500 is located at a position at which the shape detection unit 500 can image the welded portion (shape detection is possible), the shape detection control unit 34 causes the laser beam to be emitted to acquire the shape data of the welding bead in the welded portion. When the shape detection control unit 34 receives the shape data acquired by the shape detection unit 500, the shape detection control unit 34 outputs the shape data to the data processing unit 35.

The data processing unit 35 converts the shape data of the welding bead in the welded portion received from the shape detection control unit 34 into image data. The shape data is, for example, point group data of a shape line including a reflection trajectory of a laser beam emitted to a surface of the welding bead. The data processing unit 35 executes statistical processing on the received shape data, and generates image data related to the shape of the welding bead in the welded portion. In order to emphasize the position and shape of the welding bead, the data processing unit 35 may perform edge emphasis correction in which a peripheral edge portion of the welding bead is emphasized.

The determination threshold storage unit 36 stores each threshold set according to the welded portion in order to execute the determination described later according to the welded portion. Each threshold is, for example, an allowable range (threshold) related to a positional shift of the welded portion, a threshold related to a height of the welding bead, a threshold related to a width of the welding bead. The determination threshold storage unit 36 stores, as each threshold after the repair welding, an allowable range (for example, a minimum allowable value, a maximum allowable value, and the like related to the height of the welding bead) to the extent that the quality required by a customer is satisfied.

The determination threshold storage unit 36 may store an upper limit value of the number of times of inspection for each welded portion. Accordingly, the inspection device 3 can determine that it is difficult or impossible to repair the defective portion by the repair welding when the number of times of inspection exceeds a predetermined number of times of inspection during repairing for the defective portion by the repair welding, and can prevent a decrease in an operation rate of the repair welding system 1000a.

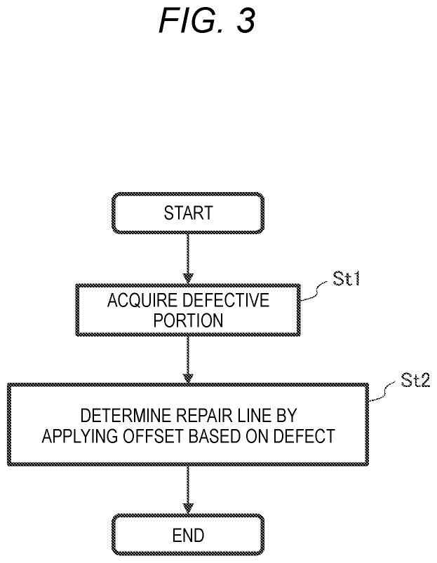

The determination unit 37 refers to the threshold stored in the determination threshold storage unit 36, and determines the welded portion based on the shape data of the welding bead in the welded portion. Details of the determination will be described later with reference to FIG. 3 and the subsequent drawings.

The determination unit 37 measures a position of the defective portion (for example, a start position and an end position of the defective portion, a position of a hole formed in the welding bead, a position of an undercut, and the like), analyzes a content of a defect, and estimates a defect factor. The determination unit 37 generates the measured position of the defective portion and the estimated defect factor as an inspection result (determination result) for the welded portion, and transmits the generated inspection result to the host device 1 via the robot control device 2.

When the determination unit 37 determines that there is no defective portion, the determination unit 37 generates an alert notifying that there is no defective portion, and transmits the generated alert to the host device 1 via the robot control device 2. The alert transmitted to the host device 1 is transmitted to and displayed on the monitor MN1.

Further, the data processing unit 35 counts the number of times of inspection for each welded portion, and when a welding inspection result is not good even if the number of times of inspection exceeds the number of times of inspection stored in the determination threshold storage unit 36, the data processing unit 35 determines that it is difficult or impossible to repair the defective portion by the repair welding. In this case, the determination unit 37 generates the alert including the position of the defective portion and the defect factor, and transmits the generated alert to the host device 1 via the robot control device 2. The alert transmitted to the host device 1 is transmitted to and displayed on the monitor MN1.

The inspection device 3 may generate an alert having contents other than those described above. The alert is also transmitted to the host device 1 via the robot control device 2. The alert transmitted to the host device 1 is transmitted to and displayed on the monitor MN1.

### Repair Determination Processing

FIG. 3 is a flowchart showing an operation procedure example of repair line determination by the repair welding system 1000a according to the first embodiment. This flowchart is based on a system configuration shown in FIG. 2. It is assumed that a repair welding control device is the inspection device 3 and a processing subject of repair line determination processing is the processor 31 of the inspection device 3. However, the repair welding control device may be the robot control device 2, and the processing subject of the repair line determination processing may be the processor 21 of the robot control device 2. The repair welding control device may be a device other than these devices, and may perform the repair line determination processing, which will be described later.

The flowchart shown in FIG. 3 shows an example in which a repair line is determined for the workpiece Wk in which the main welding is already performed and the defective portion of the welding is found by the appearance inspection of the inspection device 3.

The data processing unit 35 acquires information indicating the defective portion of the main welding in the welded portion of the workpiece Wk (step St1). The information indicating the defective portion of the main welding may include information indicating a range of the defective portion. The information indicating the defective portion of the main welding may include start point information indicating a start point of the defective portion and end point information indicating an end point of the defective portion in the main welding of the workpiece Wk. Further, the data processing unit 35 of the inspection device 3 may acquire information indicating a welded portion in the main welding of the workpiece. The information indicating the welded portion may be acquired from the host device 1 or the robot control device 2.

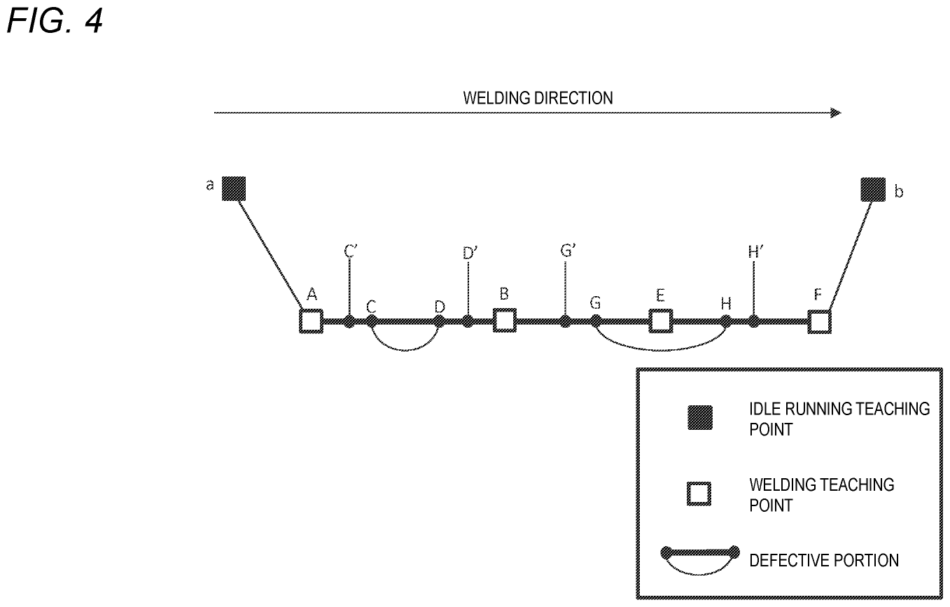

Next, the data processing unit 35 determines a repair line (step St2). The determination of the repair line will be described in detail with reference to FIG. 4 and subsequent drawings.

FIG. 4 is a conceptual diagram showing the repair line determination processing shown in FIG. 3. A welding direction in the welding line is from left to right in the drawing (see an arrow). In order to facilitate understanding, a direction opposite to the welding direction may be referred to as “front”, and the same direction as the welding direction may be referred to as “rear”.

A black square in FIG. 4 indicates an idle running teaching point. That is, before or after the idle running teaching point, the robot MC runs idle without performing welding. More specifically, the robot MC runs idle without performing welding before an idle running teaching point a and after an idle running teaching point b.

In FIG. 4, a white square indicates a welding teaching point. The welding teaching point is a teaching point indicating a start portion or an end portion of the welding. In the example of FIG. 4, there are four welding teaching points of a welding start point A, a welding end point B, a welding start point E, and a welding end point F. That is, FIG. 4 shows two welding lines, that is, a welding line from the welding start point A to the welding end point B and a welding line from the welding start point E to the welding end point F.

### First Example: Basic Case

As a result of the inspection by the inspection device 3, when a welding defective portion C-D (from a welding defect start point C to a welding defect end point D) is found between the welding start point A and the welding end point B, the processor 31 determines a welding start point at which the repair welding is to be started as C′. In other words, the processor 31 determines a first position (point C′) shifted (offset) from the welding defect start point C by a first offset distance in a direction (forward direction) opposite to the welding direction at the welded portion as a welding start point for the repair welding. Similarly, the processor 31 determines a welding end point at which the repair welding is to be ended as D′. That is, the processor 31 determines a second position (point D′) shifted (offset) from the welding defect end point D by a second offset distance in the same direction as the welding direction at the welded portion as the welding end point for the repair welding.

Here, the first offset distance and the second offset distance may be the same distance or may be different distances. Further, the first offset distance and the second offset distance may be received by a user (operator) via the interface UI1 and the like as setting values, and may be stored in the memory 32 as setting values.

As described above, the processor 31 performs the repair welding after shifting the welding start point and the welding end point of the repair welding from the defective portion by a predetermined offset distance. That is, the repair welding is performed after determining a repair welding start point indicating a start point of repair welding and a repair welding end point indicating an end point of the repair welding such that a repair welding range includes all the range of the defective portion and a range wider than the range of the defective portion. Accordingly, it is possible to perform appropriate repair welding with high quality.

The first offset distance and the second offset distance can be adjusted to increase or decrease as offset values. That is, the quality of the repair welding is stabilized by adjusting the offset value.

When the welding start point A and the welding defect start point C are located at substantially the same position, the point C′ acquired as described above may be located at a position before the welding start point A. In this case, there are a plurality of methods of determining the welding start point at which the repair welding is to be started by the processor 31. For example, the following is performed.
When the position of the point C′ is a weldable position, the processor 31 determines the point C′ as the welding start point for the repair welding.
When the position of the point C′ is not a weldable position, the first offset distance is reduced. For example, the first offset distance is reduced to half, and an intermediate point between the point C′ and the point C is determined as the welding start point for the repair welding.
When the position of the point C′ is not a weldable position, the welding start point A is directly determined as the welding start point for the repair welding.

Here, the processor 31 may set whether the position of the welding start point after the offset (the position of the point C′) is the weldable position based on the above-described shape data acquired by the shape detection unit 500. For example, the processor 31 sets that a portion before the idle running teaching point a is not the weldable position. Further, the weldable position and an unweldable position may be manually set. For example, the user (operator) may input the weldable position and the unweldable position using the interface UI1, and the weldable position and the unweldable position may be stored as a setting value in the memory 32.

Similarly to the above, when the welding end point B and the welding defect end point D are located at substantially the same position, the point D′ acquired as described above may be located at a position after the welding end point B. Also in this case, there are a plurality of methods of determining the welding end point at which the repair welding is to be ended by the processor 31.

For example, the following is performed.
When the position of the point D′ is a weldable position, the processor 31 determines the point D′ as the welding end point for the repair welding.
When the position of the point D′ is not a weldable position, the second offset distance is reduced. For example, the second offset distance is reduced to half, and an intermediate point between the point D′ and the point D is determined as the welding end point for the repair welding.
When the position of the point D′ is not a weldable position, the welding end point B is directly determined as the welding end point for the repair welding.

Here, the processor 31 may set whether the position of the welding end point after the offset (the position of the point D′) is the weldable position based on the above-described shape data acquired by the shape detection unit 500. For example, the processor 31 sets that a position after the idle running teaching point b is not the weldable position. Further, the weldable position and an unweldable position may be manually set. For example, the user (operator) may input the weldable position and the unweldable position using the interface UI1, and the weldable position and the unweldable position may be stored as a setting value in the memory 32.

### Second Example: Case where Welding Defective Portion Straddles Welding Teaching Point

Further, it is assumed that a welding defective portion G-H (from a welding defect start point G to a welding defect end point H) is found as a result of the inspection by the inspection device 3. The welding defective portion G-H straddles a welding start point E. At this time, the processor 31 determines a welding start point at which the repair welding is to be started as G′. That is, the point G′ located at a first position shifted (offset) from the welding defect start point G by a first offset distance in a direction opposite to the welding direction at the welded portion is determined as a welding start point for the repair welding. Similarly, the processor 31 determines a welding end point at which the repair welding is to be ended as H′. That is, the point H′ located at a second position shifted (offset) from the welding defect end point H by a second offset distance in the same direction as the welding direction at the welded portion is determined as the welding end point for the repair welding.

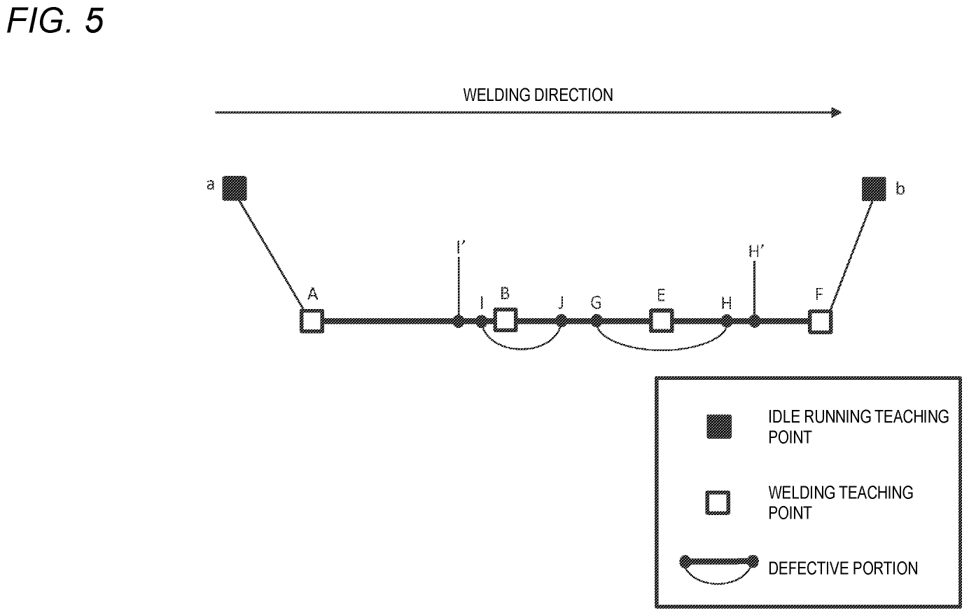

FIG. 5 is a conceptual diagram showing the repair line determination processing shown in FIG. 3. A welding direction in the welding line is from left to right in the drawing. Further, in the drawing, a black square indicates an idle running teaching point. That is, before or after the idle running teaching point, the robot MC runs idle without performing welding. More specifically, the robot MC runs idle without performing welding before the idle running teaching point a and after the idle running teaching point b.

In the drawing, a white square indicates a welding teaching point. The welding teaching point is a teaching point indicating a start portion or an end portion of the welding. In the example of FIG. 5, there are four welding teaching points of the welding start point A, the welding end point B, the welding start point E, and the welding end point F. That is, FIG. 5 shows two welding lines, that is, the welding line from the welding start point A to the welding end point B and the welding line from the welding start point E to the welding end point F.

### Third Example: Case where Defective Portions are Close to Each Other

As a result of the inspection by the inspection device 3, it is assumed that a welding defective portion I-J (from a welding defect start point Ito a welding defect end point J) and the welding defective portion G-H (from the welding defect start point G to the welding defect end point H) are found. Since the two defective portions are close to each other, the welding defect end point J and the welding defect start point G are close to each other.

At this time, a point offset from the welding defect end point J in the welding direction is denoted by J′ (not shown), and a point at which the welding start point is offset from the welding defect start point G in the direction opposite to the welding direction is denoted by G′ (not shown). Then, the point J′ and the point G′ are close to each other, or the front and back of these two points are exchanged.

In such a case, the processor 31 may collectively determine one repair line for the welding defective portion I-J (from the welding defect start point Ito the welding defect end point J) and the welding defective portion G-H (from the welding defect start point G to the welding defect end point H). In this case, the processor 31 determines a welding start point at which the repair welding is to be started as I′ and determines a welding end point at which the repair welding is to be ended as H′. In other words, the processor 31 determines the welding start point and the welding end point for the repair welding so as to perform the repair welding from the welding start point I′ for the repair welding on a first defective portion (welding defective portion I-J) to the welding end point H′ for the repair welding on a second defective portion (welding defective portion G-H).

When three or more welding defective portions continue, the processor 31 may determine the welding start point and the welding end point for the repair welding in the same manner as described above. That is, the processor 31 may collectively determine one repair line from the foremost defective portion (first defective portion) in the welding direction to the rearmost defective portion (second defective portion) in the welding direction.

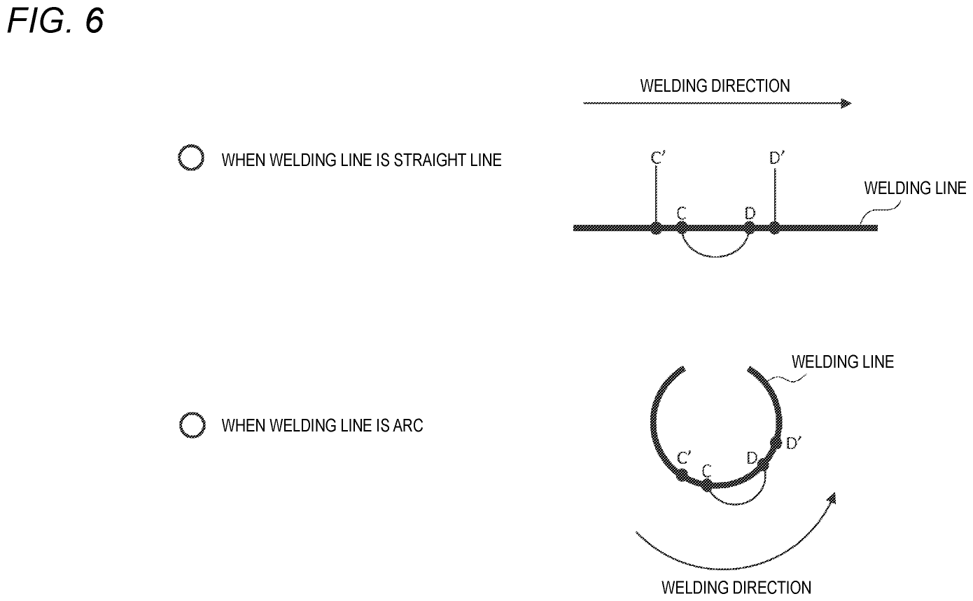

FIG. 6 is a conceptual diagram showing a pattern of a plurality of welding lines. As shown in the upper diagrams of FIGS. 4, 5, and 6, the welding may be performed in a straight line. However, the welding may be performed in a pattern other than the straight line. For example, as shown in the lower diagram of FIG. 6, the welding may be performed so as to draw an arc, or the welding may be performed three-dimensionally. Even in such a case, as described above, the processor 31 can determine a position (point C′) offset from the welding defect start point C in the direction opposite to the welding direction as the welding start point for the repair welding. Further, as described above, the processor 31 can determine a position (point D′) offset from the welding defect end point D in the same direction as the welding direction as the welding end point for the repair welding. Accordingly, even when welding is not performed in a straight line, it is possible to determine an appropriate repair line.

### Modification of First Embodiment

Hereinafter, a modification of the above-described first embodiment will be described. In the first embodiment, the welding start point for the repair welding is positioned at a position (a position offset in the direction opposite to the welding direction) returned from the welding defect start point along the welding line. Further, in the first embodiment, the welding end point for the repair welding is positioned at a position (a position offset in the welding direction) advanced from the welding defect end point along the welding line. As described above, when the welding start point or the welding end point for the repair welding is shifted (offset) from the welding defect start point or the welding defect end point, the welding start point or the welding end point for the repair welding may exceed an original welding section depending on an occurrence position of the defective portion in the main welding. For example, as described above with reference to FIG. 4, the point C′, which is a candidate for the welding start point, may be located at a position before the welding start point A. Further, the point D′, which is a candidate for the welding end point, may be located at a position after the welding end point B. Further, as described above, welding may be performed in a pattern other than a straight line (a curved line, a three-dimensional pattern, and the like). Then, when the welding start point or the welding end point for the repair welding exceeds the original welding section, there arises a new problem of where the welding start point or the welding end point is determined. As means for solving this new problem, in the modification of the first embodiment, the following three determination modes for determining the welding start point or the welding end point are selectively used.
First determination mode: a position shifted (offset) from the welding defect start point or the welding defect end point along an operation trajectory of a welding robot in the main welding is determined as the welding start point or the welding end point for the repair welding.
Second determination mode: a position shifted (offset) from the welding defect start point or the welding defect end point along a shape of a figure drawn by a welding line in the main welding is determined as the welding start point or the welding end point for the repair welding.
Third determination mode: a position rounded to an end point on the operation trajectory of the welding robot in the main welding, being the position shifted (offset) from the welding defect start point or the welding defect end point along the shape of the figure drawn by the welding line in the main welding, is determined as the welding start point or the welding end point for the repair welding.

In the modification of the first embodiment, the repair welding control device determines the welding start point or the welding end point for the repair welding by selectively using the three modes described above. Hereinafter, the three determination modes will be described in more detail.

### First Determination Mode

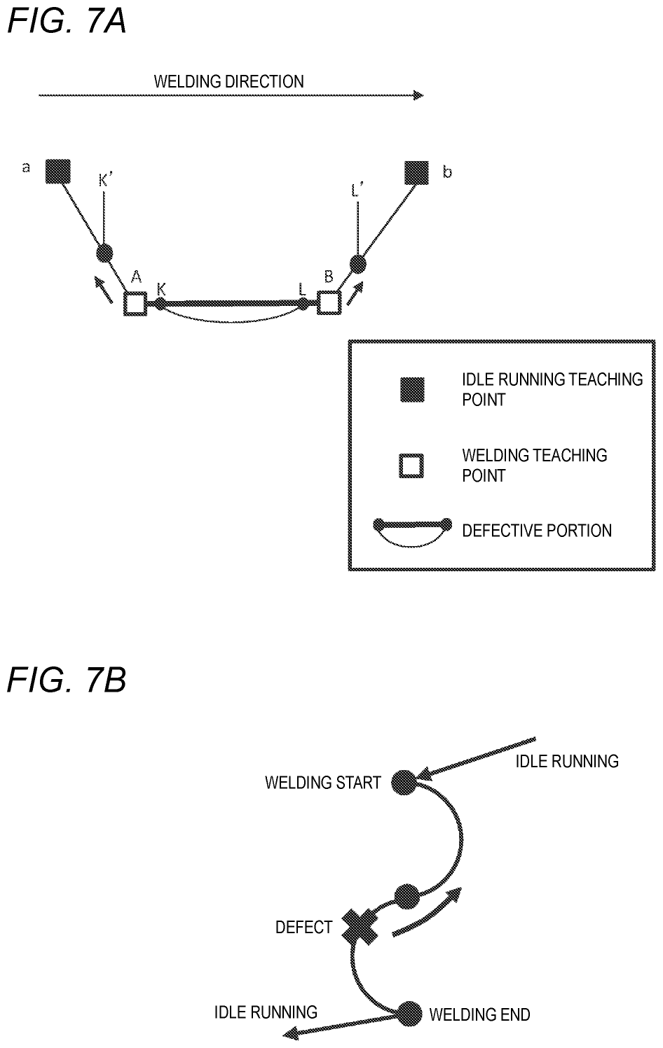

FIG. 7A is a conceptual diagram showing the first determination mode, and FIG. 7B is a conceptual diagram showing a use case of the first determination mode. Hereinafter, the first determination mode will be described in detail with reference to FIGS. 7A and 7B.

FIG. 7A shows the operation trajectory of the welding robot during the main welding in which the idle running teaching point a, the welding start point A, the welding end point B, and the idle running teaching point b are plotted. That is, the robot MC, which is a welding robot, performs the main welding from the welding start point A to the welding end point B by, for example, bringing the welding torch 400 close to the workpiece Wk after idle running until reaching the idle running teaching point a, starts idle running from the idle running teaching point b by, for example, separating the welding torch 400 from the workpiece Wk, and moves away to the next step.

As a result of the inspection by the inspection device 3, a welding defective portion K-L (from a welding defect start point K to a welding defect end point L) is found between the welding start point A and the welding end point B. Therefore, the processor 31 determines a first position (point K′) shifted (offset) from the welding defect start point K in a direction (forward direction) opposite to the welding direction at the welded portion as a welding start point for the repair welding. The welding start point (point K′) exceeds the original welding section (from the point A to the point B). In the first determination mode, since the welding start point is shifted along the operation trajectory of the welding robot, the point K′ is on a line segment from the point a to the point A, which is a part of the operation trajectory of the welding robot.

In the first determination mode, the welding end point is also the same as in the above example. That is, the processor 31 determines a second position (point L′) shifted (offset) from the welding defect end point L in the welding direction (backward direction) at the welded portion as a welding end point for the repair welding. The welding end point (point L′) exceeds the original welding section (from the point A to the point B). In the first determination mode, since the welding end point is shifted along the operation trajectory of the welding robot, the point L′ is on a line segment from the point B to the point b, which is a part of the operation trajectory of the welding robot.

As described above, an advantage of determining the welding start point or the welding end point according to the first determination mode is that it is possible to reliably prevent the welding robot from colliding with a jig and the like during repair welding. As shown in FIG. 7B, during the main welding, the welding robot starts the welding from the welding start point after idle running, ends the welding at the welding end point, and runs idle to proceed to the next step. In the example of FIG. 7B, the main welding is performed in a curved line from the welding start point to the welding end point. A route of such an operation trajectory of the main welding is determined such that the welding robot does not collide with a jig and the like. Therefore, if the repair welding is performed from the welding start point to the welding end point determined according to the first determination mode, the welding robot passes through the same route as that during the main welding. Therefore, the welding robot does not collide with a jig and the like.

### Second Determination Mode

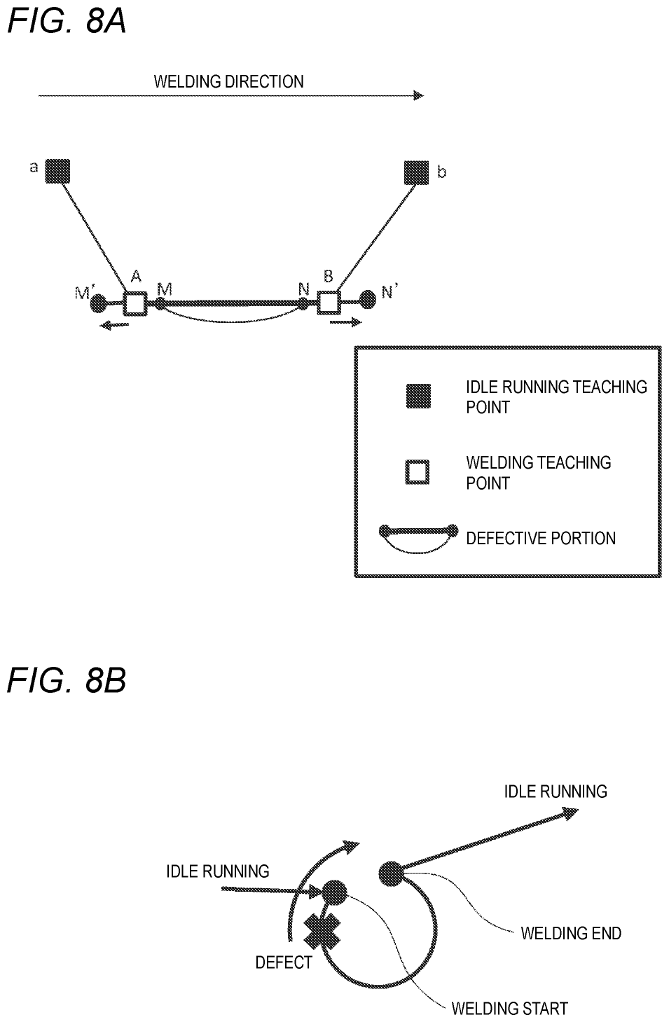

FIG. 8A is a conceptual diagram showing the second determination mode, and FIG. 8B is a conceptual diagram showing a use case of the second determination mode. Hereinafter, the second determination mode will be described in detail with reference to FIGS. 8A and 8B.

FIG. 8A shows the operation trajectory of the welding robot during the main welding in which the idle running teaching point a, the welding start point A, the welding end point B, and the idle running teaching point b are plotted. That is, the robot MC, which is a welding robot, performs the main welding from the welding start point A to the welding end point B by, for example, bringing the welding torch 400 close to the workpiece Wk after idle running until reaching the idle running teaching point a, starts idle running from the idle running teaching point b by, for example, separating the welding torch 400 from the workpiece Wk, and moves away to the next step.

As a result of the inspection by the inspection device 3, a welding defective portion M-N (from a welding defect start point M to a welding defect end point N) is found between the welding start point A and the welding end point B. Therefore, the processor 31 determines a first position (point M′) shifted (offset) from the welding defect start point M in a direction (forward direction) opposite to the welding direction at the welded portion as a welding start point for the repair welding. The welding start point (point M′) exceeds the original welding section (from the point A to the point B). Here, in the second determination mode, the processor 31 determines a position shifted (offset) from the welding defect start point or the welding defect end point along a shape of a figure drawn by a welding line in the main welding as the welding start point or the welding end point for the repair welding. In the example shown in FIG. 8A, a portion of the welding line from the welding start point A to the welding end point B is drawn in a straight line. Therefore, the processor 31 determines the point M′ shifted in the forward direction from the welding defect start point M along the shape (straight line) of the figure as a welding start point for the repair welding. The point M′, which is the welding start point for the repair welding, is not on the operation trajectory of the welding robot.

In the second determination mode, the welding end point is also the same as in the above example. That is, the processor 31 determines a second position (point N′) shifted (offset) from the welding defect end point N in the welding direction (backward direction) at the welded portion as a welding end point for the repair welding. The welding end point (point N′) exceeds the original welding section (from the point A to the point B). Here, in the second determination mode, the processor 31 determines a position shifted (offset) from the welding defect start point or the welding defect end point along a shape of a figure drawn by a welding line in the main welding as the welding start point or the welding end point for the repair welding. In the example shown in FIG. 8A, a portion of the welding line from the welding start point A to the welding end point B is drawn in a straight line. Therefore, the processor 31 determines the point N′ shifted in the backward direction from the welding defect end point N along the shape of the figure (straight line) as a welding end point for the repair welding. The point N′, which is the welding end point for the repair welding, is not on the operation trajectory of the welding robot.

As described above, an advantage of determining the welding start point or the welding end point according to the second determination mode is that the repair welding is easily performed even when there is a defect in the vicinity of the welding start point or the welding end point in the main welding. As shown in FIG. 8B, during the main welding, the welding robot starts the welding from the welding start point after idle running, ends the welding at the welding end point, and runs idle to proceed to the next step. In the example of FIG. 8B, the main welding is performed in an arc shape from the welding start point to the welding end point. When there is a defect in the vicinity of the welding start point or the welding end point in the main welding, the defect may not be eliminated even if the same portion as in the main welding is repair-welded. Therefore, a position extended along a figure (an arc in the present example) from a position having a defect is determined as the welding start point or the welding end point, and the repair welding is performed such that a welding bead is further overlapped on the welding bead formed by the main welding. Accordingly, the defect is appropriately eliminated.

A second advantage of using the second determination mode is that a repair welding program can be easily generated. In the example of FIG. 8B, the welding robot (robot MC) during the main welding performs the main welding by driving the welding bead so as to draw an arc-shaped trajectory. That is, the welding robot moves according to a welding program (main welding program) in which the welding bead is set to draw the arc-shaped trajectory. Therefore, also during the repair welding, the repair welding is similarly performed such that the welding bead draws an arc-shaped trajectory. Since the same trajectory is drawn during the main welding and during the repair welding, it is easy to change a main welding program to generate a repair welding program.

In the example of FIG. 8B, the shape of the figure drawn by the welding line is an arc, but the shape of the figure drawn by the welding line is not limited to an arc. For example, the welding line can draw various shapes such as a straight line shape and a wave shape.

### Third Determination Mode

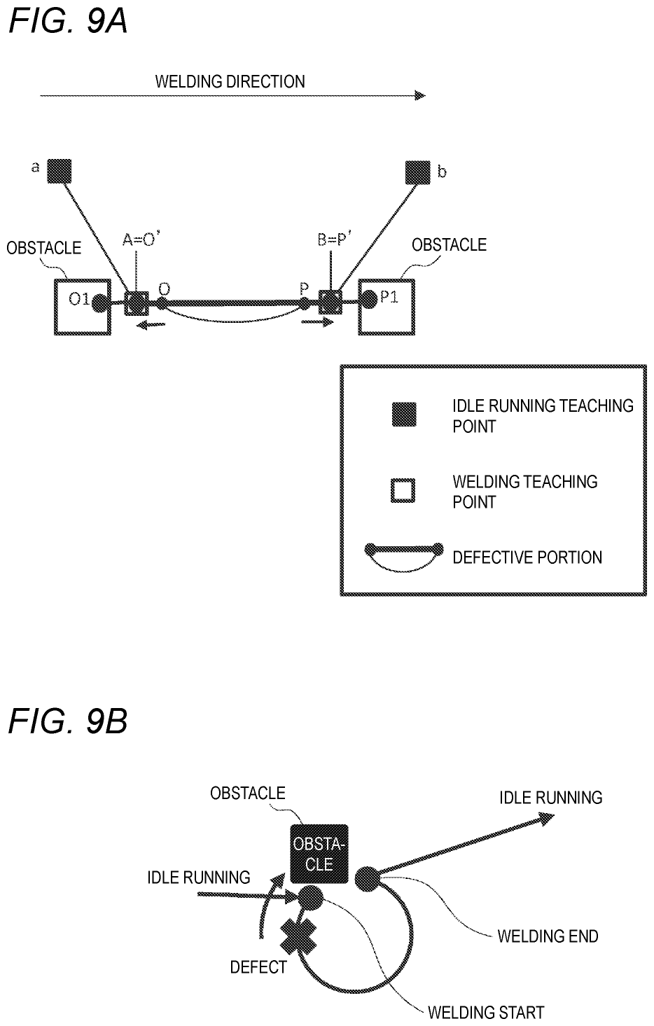

FIG. 9A is a conceptual diagram showing the third determination mode, and FIG. 9B is a conceptual diagram showing a use case of the third determination mode. Hereinafter, the third determination mode will be described in detail with reference to FIGS. 9A and 9B.

FIG. 9A shows the operation trajectory of the welding robot during the main welding in which the idle running teaching point a, the welding start point A, the welding end point B, and the idle running teaching point b are plotted. That is, the robot MC, which is a welding robot, performs the welding from the welding start point A to the welding end point B by, for example, bringing the welding torch 400 close to the workpiece Wk after idle running until reaching the idle running teaching point a, starts idle running from the idle running teaching point b by, for example, separating the welding torch 400 from the workpiece Wk, and moves away to the next step.

As a result of the inspection by the inspection device 3, a welding defective portion O-P (from a welding defect start point O to a welding defect end point P) is found between the welding start point A and the welding end point B. In the case of following the second determination mode, the processor 31 determines a first position (point O1) shifted (offset) from the welding defect start point O in a direction (forward direction) opposite to the welding direction at the welded portion as a welding start point for the repair welding. The welding start point (point O1) exceeds the original welding section (from the point A to the point B).

However, an obstacle such as a jig or a pillar is already present at the position of the point O1. Therefore, it is impossible to start the repair welding from the point O1. Therefore, in the third determination mode, the processor 31 determines a position, that is, a point O′, rounded to the point A which is an end point on the operation trajectory of the welding robot in the main welding as a welding start point. Since the end point A (point O′) is a point on the operation trajectory of the welding robot in the main welding, it is guaranteed that the welding robot does not collide with the obstacle, and it is possible to start the repair welding from the end point.

In the third determination mode, the welding end point is also the same as in the above example. That is, in the case of following the second determination mode, the processor 31 determines a second position (point P1) shifted (offset) from the welding defect end point P in the welding direction (backward direction) at the welded portion as a welding end point for the repair welding. The welding end point (point P1) exceeds the original welding section (from the point A to the point B).

However, an obstacle such as a jig or a pillar is already present at the position of the point P1. Therefore, it is impossible to perform the repair welding such that the welding is ended at the point P1. Therefore, in the third determination mode, the processor 31 determines a position, that is, a point P′, rounded to the point B which is an end point on the operation trajectory of the welding robot in the main welding as a welding end point. Since the end point B (point P′) is a point on the operation trajectory of the welding robot in the main welding, it is guaranteed that the welding robot does not collide with the obstacle, and it is possible to perform the repair welding such that the welding is ended at the end point.

As described above, an advantage of determining the welding start point or the welding end point according to the third determination mode is that the welding start point or the welding end point for the repair welding can be appropriately determined even when an obstacle (see FIG. 9B) or a region which cannot be accessed by the welding robot in design is present in the vicinity of a defective portion.

In the third determination mode described above, the processor 31 determines, as the repair welding start point or the repair welding end point, a position (point O′ or point P′) rounded to the end point (point A or point B) on the operation trajectory of the welding robot in the main welding, being the position shifted from the position (welding defect start point O or welding defect end point P) indicated by defect start point information or defect end point information along the shape of the figure drawn by the welding line in the main welding. As a modification of the determination mode, it is also conceivable to determine a point (temporarily referred to as a point X) on a line segment connecting the point O1, which is the first position, and the end point A as the repair welding start point, and determine a point (temporarily referred to as a point Y) on a line segment connecting the point P1, which is the second position, and the end point B as the welding end point. However, the point X and the point Y are positions that do not overlap with the obstacle.

### Selection of Determination Mode

In the modification, the processor 31 may determine the welding start point or the welding end point for the repair welding by selectively using the first to third determination modes described above. Further, the determination mode used for determining the welding start point for the repair welding and the determination mode used for determining the welding end point for the repair welding may be different determination modes. For example, when the presence of an obstacle near the welding defect start point in the workpiece Wk subjected to the main welding is detected by a camera (not shown) included in the repair welding system 1000 (1000a) and the like, the processor 31 may select the third determination mode to determine the welding start point for the repair welding. On the other hand, when there is no obstacle near the welding defect end point in the workpiece Wk subjected to the main welding, the processor 31 may select the first or second determination mode to determine the welding end point for the repair welding.

The user (operator) may select a determination mode among the first to third determination modes which is used by the processor 31. In this case, for example, the user (operator) may designate the determination mode via the interface UI1 connected to the host device 1 shown in FIG. 1. Further, a setting value indicating the determination mode which is used by the processor 31 may be stored in the memory 12 of the host device 1 or the external storage ST. Control information including the setting value indicating the determination mode designated by the user or control information including the setting value read from the memory 12 and the like is transmitted from the host device 1 to the inspection device 3. The processor 31 of the inspection device 3 can select the determination mode to be used based on the setting value. The setting value may be stored in advance in the memory 32 of the inspection device 3, and the processor 31 may read the setting value from the memory 32.

As described above, after the processor 31 determines the repair line, the repair welding is performed under the control of the robot control device 2. The repair welding is performed according to the repair line determined by the processor 31.

When the processor 31 determines the repair line, the above-described alert may be performed using information indicating the welding start position and the welding end position in the repair line. For example, the information indicating the welding start position and the welding end position is displayed on the monitor MN1 connected to the host device 1. The welding operator can also manually perform the repair welding on the workpiece Wk based on the display information.

Further, as described above, repair line determination processing and alert processing performed by the processor 31 may be performed by the processor 21 and the like of the robot control device 2.

As described above, the processor acquires defect start point information indicating a start point of the defective portion and defect end point information indicating an end point of the defective portion in the main welding, determines, as the repair welding start point, a first position shifted by a first predetermined distance from a position indicated by the defect start point information in a direction opposite to a welding direction, and determines, as the repair welding end point, a second position shifted by a second predetermined distance from a position indicated by the defect end point information in the welding direction. Accordingly, a more appropriate repair line can be determined based on the defect start point information and the defect end point information.

Further, the processor determines, in a case where the first position is shifted in the direction opposite to the welding direction from a welding start position in the main welding, the welding start position in the main welding as a welding start point for the repair welding. Accordingly, when a start position of the repair welding exceeds the welding start position in the main welding, the range of the repair welding can be appropriately determined.

Further, the processor determines, in a case where the second position is shifted in the welding direction from a welding end position in the main welding, the welding end position in the main welding as the welding start point for the repair welding. Accordingly, when an end position of the repair welding exceeds the welding end position in the main welding, the range of the repair welding can be appropriately determined.

Further, when a first defective portion and a second defective portion shifted in the welding direction from the first defective portion are present in a main welding portion of the workpiece, the processor acquires at least first defect start point information indicating a start point of the first defective portion and second defect end point information indicating an end point of the second defective portion, determines, as the repair welding start point, a position shifted by the first predetermined distance from a position indicated by the first defect start point information in the direction opposite to the welding direction in the welded portion, and determines, as the repair welding end point, a position shifted by the second predetermined distance from a position indicated by the second defect end point information in the welding direction in the welded portion. Accordingly, when a plurality of defective portions are close to each other, the plurality of defective portions can be collectively repair-welded by one repair line.

Further, the processor acquires defect start point information indicating a start point of the defective portion and defect end point information indicating an end point of the defective portion in the main welding, and determines the repair welding start point and the repair welding end point in accordance with at least one determination mode among a first determination mode in which a position shifted from a position indicated by the defect start point information or the defect end point information along an operation trajectory of a welding robot in the main welding is determined as the repair welding start point or the repair welding end point, a second determination mode in which a position shifted from the position indicated by the defect start point information or the defect end point information along a shape of a figure drawn by a welding line in the main welding is determined as the repair welding start point or the repair welding end point, and a third determination mode in which a position rounded to an end point on the operation trajectory of the welding robot in the main welding, being the position shifted from the position indicated by the defect start point information or the defect end point information along the shape of the figure drawn by the welding line in the main welding, is determined as the repair welding start point or the repair welding end point. Accordingly, when the welding start point or the welding end point for the repair welding exceeds the original welding section, it is possible to flexibly select a portion where the welding start point or the welding end point is determined.

Although the various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Further, constituent elements in the various embodiments described above may be arbitrarily combined within a range not departing from the gist of the invention.

The present disclosure is useful as a repair welding control device and a repair welding control method for performing repair welding for improving and stabilizing the welding quality.

What is claimed is:

1. A repair welding control device, comprising:
a memory that stores instructions; and
a processor that executes the instructions,
wherein the instructions cause the processor to perform:
acquiring information indicating a range of a defective portion in main welding of a workpiece; and
determining a repair welding start point indicating a start point of repair welding and a repair welding end point indicating an end point of the repair welding such that a repair welding range includes all the range of the defective portion and a range wider than the range of the defective portion.

2. The repair welding control device according to claim 1, wherein the instructions cause the processor to perform:
acquiring defect start point information indicating a start point of the defective portion in the main welding and defect end point information indicating an end point of the defective portion in the main welding;
determining, as the repair welding start point, a first position shifted by a first predetermined distance from a position indicated by the defect start point information in a direction opposite to a welding direction; and
determining, as the repair welding end point, a second position shifted by a second predetermined distance from a position indicated by the defect end point information in the welding direction.

3. The repair welding control device according to claim 2, wherein the instructions cause the processor to perform:
determining, in a case where the first position is shifted in the direction opposite to the welding direction from a welding start position in the main welding, the welding start position in the main welding as a welding start point for the repair welding.

4. The repair welding control device according to claim 2, wherein the instructions cause the processor to perform:
determining, in a case where the second position is shifted in the welding direction from a welding end position in the main welding, the welding end position in the main welding as the welding start point for the repair welding.

5. The repair welding control device according to claim 2, wherein
in a case where a first defective portion and a second defective portion shifted in the welding direction from the first defective portion are present in a main welding portion of the workpiece,
the instructions cause the processor to perform:
acquiring at least first defect start point information indicating a start point of the first defective portion and second defect end point information indicating an end point of the second defective portion;
determining, as the repair welding start point, a position shifted by the first predetermined distance from a position indicated by the first defect start point information in the direction opposite to the welding direction; and
determining, as the repair welding end point, a position shifted by the second predetermined distance from a position indicated by the second defect end point information in the welding direction.

6. The repair welding control device according to claim 1, wherein the instructions cause the processor to perform:
acquiring defect start point information indicating a start point of the defective portion and defect end point information indicating an end point of the defective portion in the main welding; and
determining the repair welding start point and the repair welding end point in accordance with at least one determination mode among a first determination mode, a second determination mode, and a third determination mode;
in the first determination mode, a position shifted from a position indicated by the defect start point information or the defect end point information along an operation trajectory of a welding robot in the main welding is determined as the repair welding start point or the repair welding end point;
in the second determination mode, a position shifted from the position indicated by the defect start point information or the defect end point information along a shape of a figure drawn by a welding line in the main welding is determined as the repair welding start point or the repair welding end point; and
in the third determination mode, a position rounded to an end point on the operation trajectory of the welding robot in the main welding and being shifted from the position indicated by the defect start point information or the defect end point information along the shape of the figure drawn by the welding line in the main welding, is determined as the repair welding start point or the repair welding end point.

7. A repair welding control method using a device including a processor, wherein the instructions cause the processor to perform:
acquiring information indicating a range of a defective portion in main welding of a workpiece; and
determining a repair welding start point indicating a start point of repair welding and a repair welding end point indicating an end point of the repair welding such that a repair welding range includes all the range of the defective portion and a range wider than the range of the defective portion.
